(19) United States
(12) Patent Application Publication
(10) Pub. No.: US 2005/0074035 A1
(43) Pub. Date: Apr. 7, 2005

(54) Data transfer control device and data-driven processor with the data transfer control device

(76) Inventors: Hidekazu Yamanaka, Tenri-shi (JP); Manabu Onozaki, Nara-shi (JP)

Correspondence Address: BIRCH STEWART KOLASCH & BIRCH, PO BOX 747, FALLS CHURCH, VA, 22040-0747, US

(21) Appl. No.: 10/952,856

(22) Filed: Sep. 30, 2004

(30) Foreign Application Priority Data
Oct. 3, 2003 (JP) 2003-345378 (P)

(51) Int. Cl. H04J 3/06

(52) U.S. Cl. 370/510

(57) ABSTRACT

Packet information is transferred in accordance with a request pulse from a preceding stage to a next stage via a signal producing/taking-in circuit. While a C-element in the next stage is outputting a plurality of request pulses prepared by copying based on number data, another C-element issues the request pulse to a further next stage when an erase period indicated by an erase instruction ends. In this operation, an input sent from an external device and held in a register is transferred to the further next stage via a terminal together with requested data. The erase period indicated by the erase instruction can be arbitrarily adjusted according to externally applied information. Therefore, a difference in access sequence between the devices is absorbed by using the erase instruction, and the packet information can be transferred to the next stage in a self-synchronous manner.

This nonprovisional application is based on Japanese Patent Application No. 2003-345378 filed with the Japan Patent Office on Oct. 3, 2003, the entire contents of which are hereby incorporated by reference.

### BACKGROUND OF THE INVENTION

1. Field of the Invention

The present invention relates to a data transfer control device having a self-synchronous data transfer control function as well as a data-driven processor provided with the data transfer control device. Particularly, the invention relates to a data transfer control device, which produces a signal by using transferred data and outputs the signal thus produced, and a data-driven processor (i.e., processor of a data-driven type) provided with the data transfer control device.

2. Description of the Background Art

As a result of increase in circuit scale and miniaturization of processes, resistances relating to interconnections, line capacitances and interconnection lengths have increased, and thereby the influence exerted by the interconnections on delay in circuits have been increasing. In a clock-synchronous circuit (e.g., clock-synchronous von Neumann computer), it is necessary to distribute clock throughout a circuit with an equal delay. However, it is becoming difficult to distribute the clock while suppressing skew or variations in clock delay. Due to the increase in skew, it is becoming difficult to improve an operation frequency of a clock-synchronous circuit and to provide a layout, which allows circuits to operate according to correct timing (and thus achieves timing convergence).

Therefore, such data-driven processors have been studied that have a self-synchronous transfer control function, and thus does not require an equal delay when distributing the clocks throughout the circuit. The data-driven processor has a pipeline series, which is formed of pipelines arranged in multiple stages and successively connected together, for allowing parallel processing. A register in the pipeline forming each stage is driven by a clock provided from a self-synchronous transfer control circuit, which is arranged in the pipeline forming each stage independently of those in the other stages. The self-synchronous transfer control circuits provided for the pipelines in the neighboring stages locally perform a handshake of signals when the clock is transferred successively through the pipelines in the multiple stages connected together. In the data-driven processor, a packet containing control information and data is transferred through the registers of the pipelines in the respective stages in accordance with the above clock, and thereby the data in the packet is successively processed in accordance with the control information in the packet. The clock distribution with an equal delay is required only in the registers of the pipelines, which are driven by the output clocks of the respective self-synchronous transfer control circuits. Therefore, it is possible to avoid the increase in clock skew, which may be caused by increase in circuit scale and miniaturization of processes. Consequently, the improvement of the operation frequency and the timing convergence of the layout can be achieved easily.

Japanese Patent Laying-Open No. 2001-282765 has disclosed an example of a data-driven processor having the self-synchronous transfer control function described above. Also, FIG. 14 shows an example of a circuit structure of a conventional signal producing/taking-in circuit, which is arranged in a data-driven processor having a self-synchronous transfer control function for transmitting signals to and from external devices such as a RAM (Random Access Memory), a ROM (Read Only Memory) and a CPU (Central Processing Unit).

Referring to FIG. 14, a conventional signal producing/taking-in circuit 1005 includes pipelines P1 and P2, a delay element 605 for timing adjustment, a signal producing circuit 606, which produces and sends an output 618 based on a handshake signal and packet information PD, an output select circuit 607 formed of a combination circuit, which determines based on packet information PD whether a signal input 617 is to be taken in or not, and issues a select signal 630, and a selector 608, which selectively receives packet information PQ1 (a whole of a part of packet information PQ or D) and signal input 617 based on select signal 630 sent from output select circuit 607, and outputs the selected information or signal. Output 618 represents an I/O control output or other signal outputs. Pipeline P1 includes a self-synchronous transfer control circuit (which will be referred to as a “C-element” hereinafter) 601 and a register 603 corresponding to each other. Pipeline P2 includes a C-element 602 and a register 604 corresponding to each other. The packet information is transferred from the left to the right in FIG. 14.

Further, signal producing/taking-in circuit 1005 includes a terminal 609 receiving a signal CI, which are variable between two states representing handshake request and handshake completion, respectively, and is sent from a pipeline also sending packet information PD to signal producing/taking-in circuit 1005. This pipeline will be referred to as a “preceding pipeline” hereinafter, and is located to the left of pipeline P1 in FIG. 14 although not shown). Signal producing/taking-in circuit 1005 further includes a terminal 610 outputting a signal RO, which are variable between two states respectively representing acceptance and allowance of the handshake request provided from terminal 609, and a terminal 611 issuing a signal CO variable between two states respectively representing handshake request and handshake completion to a pipeline, to which signal producing/taking-in circuit 1005 also sends packet information PQ. This pipeline will be referred to as a “next pipeline” hereinafter, and is arranged on the right to pipeline P2 in FIG. 14 although not shown. Signal producing/taking-in circuit 1005 further includes a terminal 612 receiving a signal RI variable between two states, which represent reception and allowance of the handshake request provided from terminal 611, respectively, a terminal 613 for receiving a signal MRB resetting signal producing/taking-in circuit 1005 to an initial state, a terminal 614 receiving packet information PD transferred from the preceding pipeline, a terminal 615 for providing packet information PQ to the next pipeline, and a terminal 616 for receiving a signal DLY designating a delay amount of delay element 605. For the sake of convenience, it is assumed that each of signals CI and CO has two states of “0” and “1” representing “request” and “completion”, respectively, and that each of signals RI and RO has two states of “0” and “1” representing “reception” and “allowance”, respectively. Each packet information PD, PQ or Q1 includes data to be processed during transfer through the pipeline series, and control information for controlling processing of the data.

Terminals 614, 615 and 616 as well as a terminal (not shown) for signal input 617 and a terminal (not shown) for output 618 are terminals of a bus, of which bus width is not restricted, and depends on requirements in a system. FIG. 15 shows by way of example a structure, in which signal producing/taking-in circuit 1005 shown in FIG. 14 is arranged in a data-driven processor PR1. For the sake of simplicity, FIG. 15 does not show other elements (e.g., an arithmetic portion, program storage portion and ignition control portion), which operate while data is being transferred via the pipelines, in data-driven processor PR1.

In FIG. 15, data-driven processor PR1 includes pipelines P0 and P3, signal producing/taking-in circuit 1005, an I/O buffer 1006 and terminals 1011-1017. Terminals 1011-1017 have functions similar to those of terminals 609-615 already described in connection with signal producing/taking-in circuit 1005 in FIG. 14. Data-driven processor PR1 connects via an external bus 1010 to various devices 1007, 1008 and 1009 such as a RAM, ROM and CPU. Pipeline P0 has a C-element 1001 and a register 1003 kept in a corresponding relationship, and pipeline P3 has a C-element 1002 and a register 1004 kept in a corresponding relationship.

Referring to FIG. 15, signal producing/taking-in circuit 1005 is interposed between pipelines P0 and P3 for taking in signal input 617 from various devices 1007-1009 such as a RAM, ROM, CPU and others via I/O buffer 1006 and external bus 1010, producing signals and sending them as signal output 618 to various devices 1007-1009.

FIG. 16 shows internal structures of the C-elements (self-synchronous transfer control circuits 601 and 602) in FIG. 14 and C-elements (self-synchronous transfer control circuits 1001 and 1002) in FIG. 15. In FIG. 16, the C-element includes terminals 801-806, flip-flops 807 and 808, a logic circuit 809 and a delay element 810. Terminals 801-805 have functions similar to those of terminals 609-613 in FIG. 6.

Terminal 806 receives signal CI, which represents “completion of handshake” and is sent from the preceding pipeline via terminal 801, as well as signal RI, which represents “allowance of handshake” and is sent from the next pipeline via terminal 804, and supplies a clock CP to the register corresponding to the pipeline in this stage via terminal 806. Flip-flop 807 holds a state of acceptance of the handshake request, which is represented by signal CI received from the preceding pipeline via terminal 801. Flip-flop 808 holds a state of sending of the handshake request to the next pipeline represented by signal CO, which is output via terminal 803. Logic circuit 809 achieves synchronization between the input of signal CI, the input of signal RI, flip-flop 807 and flip-flop 808. Delay element 810 receives the output of flip-flop 808, and delays it for providing signal CO to terminal 803.

An operation of the C-element (self-synchronous transfer control circuit) shown in FIG. 16 will now described with reference to a timing chart of FIG. 17.

When the C-element in a handshake-allowed state 901 in FIG. 17 receives handshake request 902 represented by signal CI from the preceding pipeline via terminal 801, the state of flip-flop 807 changes, and handshake reception 903 represented by signal RO is provided via terminal 802 to the preceding pipeline. In response to this, the preceding pipeline will issue signal CI after a predetermined time. When handshake completion 904 represented by this signal CI is received via terminal 801, logic circuit 809 determines that the handshake is completed and the next pipeline is in a handshake-allowed state 905 so that flip-flops 807 and 808 change their states. Thereby, handshake allowance 906 of signal RO is sent to the preceding pipeline, and terminal 806 outputs a rising edge 907 of clock CP. The register corresponding to this C-element receives and holds the information of the packet applied from the preceding pipeline in response to rising edge 907 of clock CP. At the same time, this information is sent to the next pipeline. By this operation, the handshake between the preceding and this pipelines is generally completed.

With a delay of a predetermined time determined by delay element 810, handshake request 908 of signal RO is sent to the next pipeline via terminal 803. In response to this, the next pipeline sends handshake reception 909 as signal RI, and this is received via terminal 804 so that flip-flop 808 changes its state. Thereby, terminal 806 issues a falling edge 910 of clock CP. With a delay of a predetermined time determined by delay element 810, handshake completion 911 is sent as signal CO via terminal 803 to the next pipeline. In response to this, the next pipeline sends handshake allowance 912 of signal RI, and this is received via terminal 804. By this operation, the handshake between this pipeline and the next pipeline is generally completed.

Through the operations described above, the clock is propagated from the preceding pipeline to this pipeline, and from this pipeline to the next pipeline, and the data is transferred similarly.

An operation of the signal producing/taking-in circuit in FIG. 14 will now be described with reference to a timing chart of FIG. 18. In the timing chart of FIG. 18, the same signals as those in FIG. 14 bear the same reference numbers. In response to the handshake request sent from the preceding pipeline, handshake is performed between the preceding pipeline and C-element 601 (see state 701), and register 603 corresponding to C-element 601 receives and holds packet information PD in response to the output (see state 702) of clock CP 1 sent from C-element 601. The information thus held is output as packet information Q1 (see state 703). In response to this, signal producing circuit 606 sends a part of output 618 (see state 704). Subsequently, handshake is performed between C-elements 601 and 602 with signals C1-C3 and signal R (see state 705), and signal producing circuit 606 sends the remaining part of output 618 in response to change in handshake request/completion signal C2 adjusted by delay element 605 (see state 706). The I/O control output and signal output of output 618 change according to the same timing. In response to the completion of the handshake between C-elements 601 and 602, C-element 602 issues clock CP2 (see state 707), and register 604 receives and holds part Q1 of the packet information held in register 603 and the output information of selector 608 (see state 708). Selector 608 selects the remaining of the packet information or signal input 617 based on determination of output select circuit 607 according to part Q1 of the packet information, and provides the selected information or signal to register 604.

Finally, C-element 602 issues the handshake request to the next pipeline, and handshake is performed between C-element 602 and the next pipeline (see state 709). Through the operations described above, the signal production (output 618) and signal take-in (signal input 617) are performed in accordance with packet information PD transferred from the preceding pipeline.

In the conventional structure, as described above, the timing of producing and taking in the signals can be adjusted to a certain extent by changing an amount of delay in delay element 605. However, the sequence itself, which determines the order of the operations of producing the signal and taking in the signal, cannot be freely changed unless the circuit structure can be changed. This is because the above sequence itself depends on timing of changes of contents of the registers in the pipelines and timing of changes of the handshake signals to be referred to, and these are fixed by the circuit structures.

Therefore, the signal producing/taking-in circuit, e.g., for accessing a RAM of an external device from the data-driven processor can perform the minute adjustment or the like of the access timing by changing the delay mount of delay element 605, but the signal producing/taking-in circuit for accessing the RAM cannot be used for another kind of device, which can be accessed from the data-driven processor in a sequence different from the sequence for the RAM. Therefore, different signal producing/taking-in circuits such as a signal producing/taking-in circuit for accessing a ROM and a signal producing/taking-in circuit for accessing a CPU must be prepared for different devices operating as targets of signal production (output 618) and take-in (signal input 617) of the data-driven processor, respectively. As described above, the signal producing/taking-in circuit cannot be widely or universally utilized, and this results in a problem that the circuit scale increases with increase in kind of access target devices.

### SUMMARY OF THE INVENTION

Accordingly, an object of the invention is to provide a data transfer control device, which allows access to devices respectively having different access sequences while controlling self-synchronous data transfer, as well as a data-driven processor having such a data transfer control device.

For achieving the above object, an aspect of the invention provides a data transfer control device for transferring a request pulse applied for data transfer from a preceding stage to a next stage based on an instruction signal instructing allowance or prohibition of the data transfer.

This data transfer control device includes first and second self-synchronous transfer control circuits, a requested data register, an erase instructing circuit producing the erase instructing signal based on applied information, and providing the erase instructing signal to the second self-synchronous transfer control circuit, and an input register.

The first self-synchronous transfer control circuit receives the request pulse from the preceding stage, copies the received request pulse based on received number data, and successively outputs the request pulses produced by the copying.

The requested data register receives and holds the requested data sent from the preceding stage and requested as data to be transferred in response to every input of the request pulse by the first self-synchronous transfer control circuit.

The second self-synchronous transfer control circuit outputs the received request pulse to the next stage in response to every reception of the request pulse sent from the first self-synchronous transfer control circuit during a period except for an erase period indicated by the applied erase instruction signal. The second self-synchronous transfer control circuit suppresses the output of the received request pulse to the next stage in response to every reception of the request pulse sent from the first self-synchronous transfer control circuit during the erase period.

The input register receives and holds data externally applied to the data transfer control device in response to every reception of the request pulse by the second self-synchronous transfer control circuit. When the second self-synchronous transfer control circuit sends the request pulse to the next stage, contents of the input register are output as the requested data to the next stage.

Therefore, in the operation of transferring the data from the preceding stage to the next stage, the first self-synchronous transfer control circuit issues the plurality of request pulses produced by copying based on the number data after it receives the request pulse from the preceding stage. During the period, which is defined after the above reception of the request pulse and before the completion of the above pulse issuance, but does not include the erase period indicated by the erase instruction signal, the second self-synchronous transfer control circuit transfers the externally applied input data, which is currently held in the input register, to the next stage as the requested data. Since the erase instructing circuit produces the erase instruction signal based on the applied information, the timing of transferring the externally applied input data to the next stage can be arbitrarily adjusted in accordance with the information applied to the erase instructing circuit.

Accordingly, even if the access from the data transfer control device to each device is performed in a sequence different from those for the other devices, the timing of transferring the input data in the self-synchronous manner from each device to the next stage can be determined in accordance with a difference in access sequence between the devices by using the number data or the information applied to the erase instructing circuit.

Therefore, the plurality of devices using the different access sequences can share the same data transfer control device.

Preferably, the device further includes a number data producing portion producing the number data based on the requested data applied from the preceding stage, and providing the number data to the first self-synchronous transfer control circuit.

Therefore, the number data, which is used for absorbing the difference in access sequence between the devices as described above, can be determined based on the requested data transferred and received from the preceding stage.

Preferably, the device further includes a counter circuit counting the request pulses successively sent from the first self-synchronous transfer control circuit when the counter circuit receives the request pulse from the preceding stage, and providing a count.

Therefore, the count provided from the counter circuit can represent the position, in the order of copying, of the request pulse provided from the first self-synchronous transfer control circuit.

Preferably, the erase instructing circuit produces the erase instructing signal based on the requested data held in the requested data register and the count provided from the counter circuit.

Therefore, the timing of transferring the externally applied data, which is indicated by the erase instructing signal, to the next stage is based on the requested data received from the preceding stage and the count provided from the counter circuit, is synchronous with the timing of receiving the request pulse by the second self-synchronous transfer control circuit, and can be determined based on the requested data.

Preferably, the erase instructing circuit produces the erase instructing signal based on the requested data held in the requested data register, the count provided from the counter circuit and an externally applied erase parameter.

Therefore, the timing of transferring the externally applied data, which is indicated by the erase instructing signal, to the next stage is based on the requested data received from the preceding stage and the count provided from the counter circuit, is synchronous with the timing of receiving the request pulse by the second self-synchronous transfer control circuit, and can be arbitrarily determined based on the requested data and the erase parameter externally applied to the data transfer control device.

Preferably, the device further includes an external register receiving, holding and externally providing output data to be provided externally based on a load signal in response to every reception of the requested pulse by the second self-synchronous transfer control circuit, and a signal producing portion producing and sending the output data and the load signal to the external register.

The load signal instructs the external register to update or not to update contents held in the external register with the output data:

Therefore, when the data transfer control device transfers the requested data from the preceding stage to the next stage, the data to be provided to a device external to the data transfer control device can be produced, and can be provided to the external device or the like.

Preferably, the signal producing portion produces the output data and the load signal based on the requested data held in the requested data register and the count provided from the counter circuit, and provides the output data and the load signal to the external register.

Therefore, the data to be provided to the external device and the timing of the output are updated and output in accordance with the requested data received from the preceding stage and timing indicated by the count provided from the counter circuit, and thus the timing synchronous with the timing of reception of the request pulse by the second self-synchronous transfer control circuit.

Preferably, the signal producing portion produces the output data and the load signal based on the requested data held in the requested data register, the count provided from the counter circuit and an externally applied load parameter, and provides the output data and the load signal to the external register.

Therefore, the data to be provided to the external device and the timing of the output are determined in accordance with the requested data received from the preceding stage and the count provided from the counter circuit, and thus the timing synchronous with the timing of reception of the request pulse by the second self-synchronous transfer control circuit, as well as the load parameter externally applied to the data transfer control device.

Preferably, the device further includes a holding register receiving and holding the requested data held in the requested data register in response to reception of the requested pulse by the second self-synchronous transfer control circuit, a selector outputting contents of the holding register or contents of the input register based on an applied select signal, and a select signal producing circuit producing and sending the select signal to the selector.

Therefore, both or either one of the requested data received from the preceding stage and the externally applied data can be selected as the requested data to be transferred to the next stage based on the select signal, and can be transferred to the next stage in accordance with the request pulse.

Preferably, the select signal producing circuit produces and sends the select signal to the selector based on the requested data held in the holding register.

Therefore, the select signal can be determined based on the requested data provided from the preceding stage.

Preferably, the select signal producing circuit produces and sends the select signal to the selector based on the requested data held in the holding register and the count provided from the counter circuit.

Accordingly, the select signal and the select timing are determined based on the requested data provided from the preceding stage and the timing represented by the count, i.e., the timing synchronous with the timing of reception of the request pulse by the second self-synchronous transfer control circuit.

Preferably, the select signal producing circuit produces and sends the select signal to the selector based on the requested data held in the holding register, the count provided from the counter circuit and an externally applied select parameter.

Therefore, the select signal and the timing of selection can be determined based on the requested data applied from the preceding stage, the timing represented by the count and the select parameter externally applied to the data transfer control device.

For achieving the foregoing object, another aspect of the invention provides a data transfer control device for receiving a request pulse applied for data transfer from a preceding stage based on an instruction signal instructing allowance and prohibition of the data transfer.

This data transfer control device includes first and second self-synchronous transfer control circuits, a requested data register, an external register and a signal producing portion.

The first self-synchronous transfer control circuit receives the request pulse from the preceding stage, copies the request pulse based on received number data, and successively outputs the request pulses produced by the copying.

The requested data register receives and holds the requested data sent from the preceding stage and requested as data to be transferred in response to every input of the request pulse from the first self-synchronous transfer control circuit.

The second self-synchronous transfer control circuit receives the request pulse provided from the first self-synchronous transfer control circuit.

The external register receives, holds and externally provides output data to be provided externally based on a load signal in response to every reception of the request pulse by the second self-synchronous transfer control circuit.

The signal producing portion produces and sends the output data and the load signal to the external register. The load signal instructs the external register to update or not to update contents held in the external register with the output data.

Therefore, in the operation of receiving the request pulse and the data provided from the preceding stage by the next stage, the output data is produced and sent to the external device based on the requested data received from the preceding stage while the plurality of request pulses prepared by copying based on the number data are being output. This output data is updated in accordance with the timing based on the requested data.

Accordingly, even if the access from the data transfer control device to each external device is performed in a sequence different from those for the other external devices, and thus even if the timing of updating the output data for each external device is different from that for the other external devices, the updated data can be output in accordance with the timing matching with the requested data. Therefore, the data can be output to the respective devices according to appropriate timing depending on the requested data. Consequently, the plurality of devices using the different access sequences can share the same data transfer control device.

Preferably, the data transfer control device further includes a counter circuit counting the request pulses successively sent from the first self-synchronous transfer control circuit when the counter circuit receives the request pulse from the preceding stage, and providing a count. The signal producing portion produces the output data and the load signal based on the requested data held in the requested data register and the count provided from the counter circuit, and provides the output data and the load signal to the external register.

Therefore, the value of the output data and the update timing of the externally applied output data can be determined based on the requested data received from the preceding stage and the count, i.e., the timing of successively receiving the copied request pulses sent from the first self-synchronous transfer control circuit by the second self-synchronous transfer control circuit.

Preferably, the data transfer control device further includes a counter circuit counting the request pulses successively sent from the first self-synchronous transfer control circuit when the counter circuit receives the request pulse from the preceding stage, and providing a count. The signal producing portion produces the output data and the load signal based on the requested data held in the requested data register, the count provided from the counter circuit and an externally applied load parameter, and provides the output data and the load signal to the external register.

Therefore, the value of the output data and the update timing of the externally applied output data can be determined based on the requested data received from the preceding stage, the count, i.e., the timing of successively receiving the copied request pulses sent from the first self-synchronous transfer control circuit by the second self-synchronous transfer control circuit, and the arbitrary load parameter externally applied to the data transfer control device.

For achieving the foregoing object, still another aspect of the invention provides a data-driven processor including a pipeline series formed of pipelines arranged in multiple stages and connected together and a data transfer control device arranged in the pipeline series and located between the arbitrary pipelines for transferring a request pulse used for data transfer and applied from the preceding pipeline to the next pipeline based on an instruction signal instructing allowance or prohibition of the data transfer.

This data transfer control device includes first and second self-synchronous transfer control circuits, a requested data register, an erase instructing circuit producing the erase instructing signal based on applied information, and providing the erase instructing signal to the second self-synchronous transfer control circuit, and an input register.

The first self-synchronous transfer control circuit receives the request pulse from the preceding pipeline, copies the request pulse based on received number data, and successively outputs the request pulses produced by the copying.

The requested data register receives and holds the requested data sent from the preceding pipeline and requested as data to be transferred for data-driven processing in response to every input of the request pulse from the first self-synchronous transfer control circuit.

The second self-synchronous transfer control circuit outputs the received request pulse to the next pipeline in response to every reception of the request pulse sent from the first self-synchronous transfer control circuit during a period except for an erase period indicated by the applied erase instruction signal. The second self-synchronous transfer control circuit suppresses the output of the received request pulse to the next pipeline in response to every reception of the request pulse sent from the first self-synchronous transfer control circuit during the erase period.

The input register receives and holds data externally applied to the data transfer control device in response to every reception of the request pulse by the second self-synchronous transfer control circuit.

When the second self-synchronous transfer control circuit sends the request pulse to the next pipeline, contents of the input register are output as the requested data to the next pipeline.

Therefore, in the operation of transferring the requested data to be processed in a data-driven manner while transferring the request pulse from the preceding pipeline to the next pipeline, the plurality of request pulses produced by copying based on the number data are issued from the first self-synchronous transfer control circuit, and are received by the second self-synchronous transfer control circuit. During the period, in which the above reception and issuance of the request pulses are performed but the erase instruction signal does not indicate erase period, the externally applied input data, which is currently held in the input register, is transferred to the next stage as the requested data. Since the erase instructing circuit produces the erase instructing signal based on the applied information, the timing of transferring the input data held in the input register to the next stage can be arbitrarily adjusted in accordance with the information applied to the erase instructing circuit.

Therefore, a difference in access sequence between the devices is absorbed by using the number data and information provided from the erase instructing circuit, and the input data can be transferred from each device to the next stage in a self-synchronous manner according to the data-driven type.

Therefore, the plurality of devices using the different access sequences can share the same data transfer control device. Consequently, it is possible to suppress the increase in scale of the structure of the data-driven processor.

For achieving the foregoing object, still another aspect of the invention provides a data-driven processor including a pipeline series formed of pipelines arranged in multiple stages and connected together; and a data transfer control device connected to a downstream end of the pipeline series.

This data transfer control device includes first and second self-synchronous transfer control circuits, a requested data register, an external register, and a signal producing portion.

The first self-synchronous transfer control circuit operates based on an instructing signal instructing allowance and prohibition of transfer of data to be processed, receives a request pulse for the data transfer from the preceding pipeline, copies the request pulse based on received number data, and successively outputs the request pulses produced by the copying.

The requested data register receives and holds the requested data sent from the preceding pipeline and requested as data to be transferred in response to every input of the request pulse from the first self-synchronous transfer control circuit.

The second self-synchronous transfer control circuit outputs the received request pulse in response to every reception of the request pulse sent from the first self-synchronous transfer control circuit.

The external register receives, holds and externally provides output data to be provided externally with respect to the data-drive processor based on a load signal in response to every reception of the request pulse by the second self-synchronous transfer control circuit.

The signal producing portion produces and sends the output data and the load signal to the external register. The load signal instructs the external register to update or not to update contents held in the external register with the output data.

During the period of issuing the plurality of request pulses prepared by the copying based on the number data, the output data is produced based on the requested data received from the preceding stage, and is provided to an external device. This output data is updated according to timing based on the requested data.

Accordingly, even if the access from the data-drive processor to each external device is performed in a sequence different from those for the other external devices, and thus even if the timing of updating the output data for each external device is different from that for the other external devices, the difference in access sequence between the devices can be absorbed by using the requested data, and the updated data can be output to each device in accordance with the appropriate timing. Therefore, the plurality of devices using the different access sequences can share the same data transfer control device. Therefore, increase in structure scale of the data-driven processor can be suppressed even if the data-driven processor is configured to access the plurality of devices.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a signal producing/taking-in circuit according to a first embodiment of the invention.

FIG. 2 shows an example of contents of packet information handled in embodiments of the invention.

FIG. 3 is a block diagram of a data-driven processor having the signal producing/taking-in circuit arranged therein according to the first embodiment.

FIG. 4 is a block diagram of a self-synchronous transfer control circuit with a copy function according to the first embodiment.

FIG. 5 is a timing chart illustrating an operation of the self-synchronous transfer control circuit with the copy function according to the first embodiment.

FIG. 6 is a block diagram of the self-synchronous transfer control circuit with an erase function according to the first embodiment.

FIG. 7 is a timing chart for illustrating an operation of the self-synchronous transfer control circuit with the erase function according to the first embodiment.

FIGS. 8A-8N are timing charts illustrating operations of the signal producing/taking-in circuit according to the first embodiment.

FIG. 9 is a block diagram of a signal producing circuit according to a second embodiment.

FIG. 10 is a block diagram of a data-driven processor including the signal producing circuit according to the second embodiment.

FIG. 11 shows a structure of a general data-driven processor.

FIG. 12 shows a structure having the data-driven processor shown in FIG. 11 and the signal producing/taking-in circuit of the first embodiment arranged therein.

FIG. 13 shows a structure having the data-driven processor shown in FIG. 11 and the signal producing/taking-in circuit of the second embodiment arranged therein.

FIG. 14 is a block diagram of a conventional signal producing/taking-in circuit.

FIG. 15 is a block diagram of a data-driven processor including the conventional signal producing/taking-in circuit.

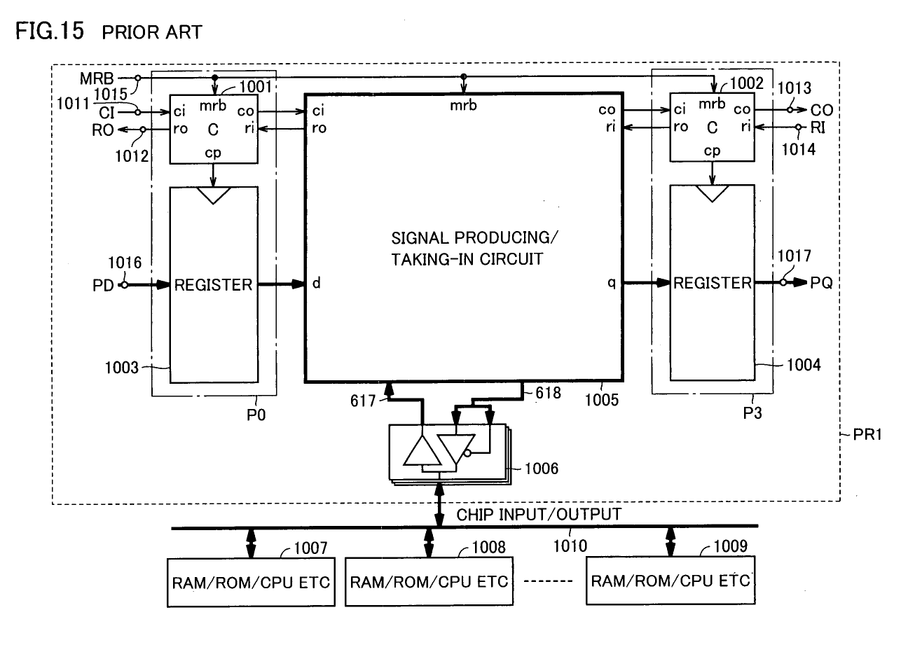

FIG. 16 shows a structure of a conventional self-synchronous transfer control circuit.

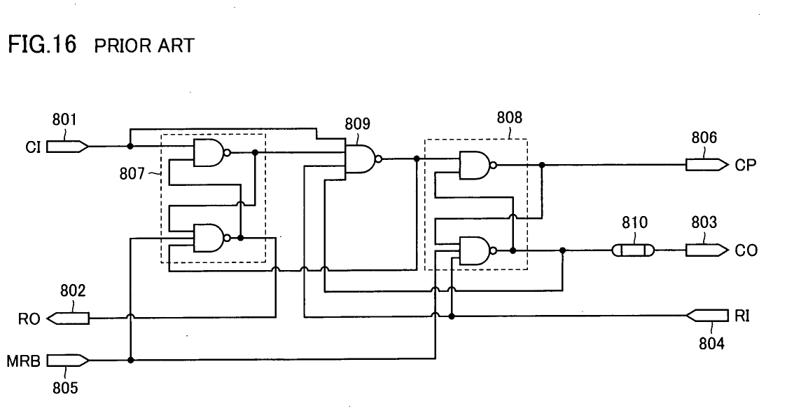

FIG. 17 is a timing chart for illustrating an operation of the conventional self-synchronous transfer control circuit.

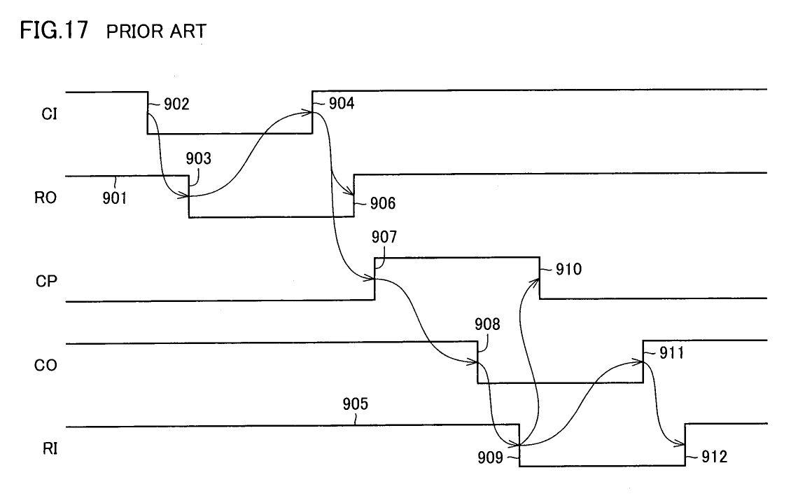

FIG. 18 is a timing chart for illustrating an operation of the signal producing/taking-in circuit shown in FIG. 14.

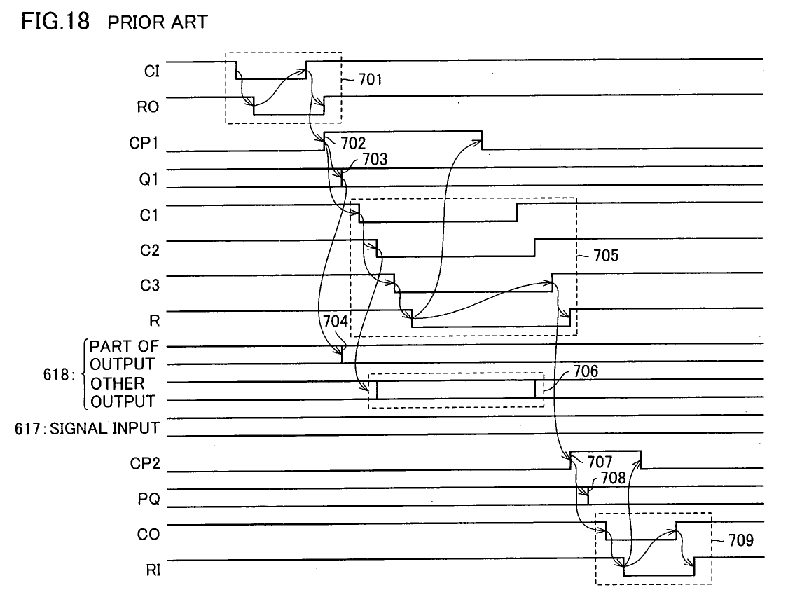

### DESCRIPTION OF THE PREFERRED EMBODIMENTS

Embodiments of the invention will now be described with reference to the drawings.

(First Embodiment)

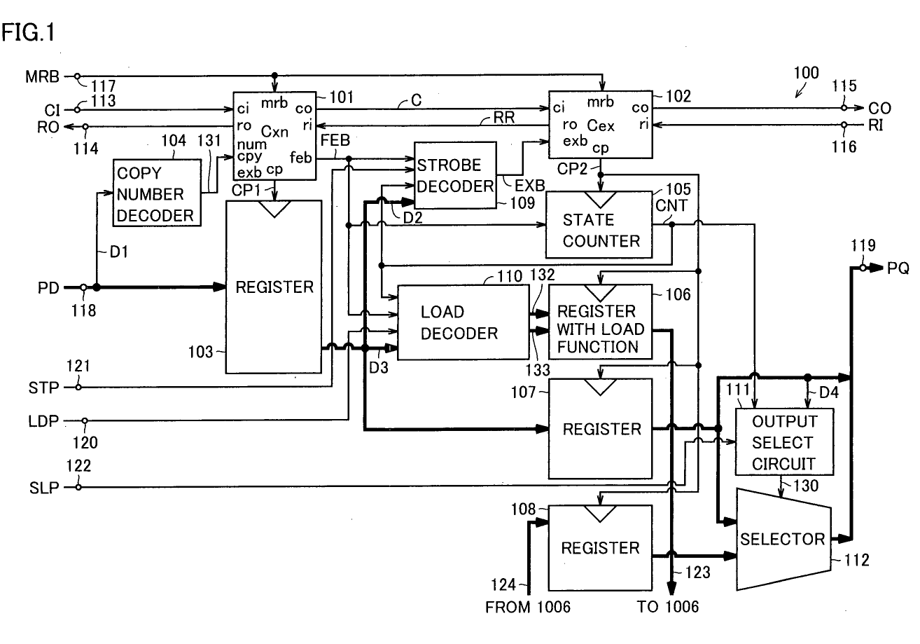

FIG. 1 shows a structure of a signal producing/taking-in circuit 100 according to a first embodiment. In signal producing/taking-in circuit 100, a self-synchronous data transfer control circuit transfers a signal CI (a request pulse for data transfer) applied from a pipeline (or a C-element) in a preceding stage to a pipeline (or a C-element) in a next stage based on a transfer allowance signal RO or RI representing allowance of prohibition of the data transfer.

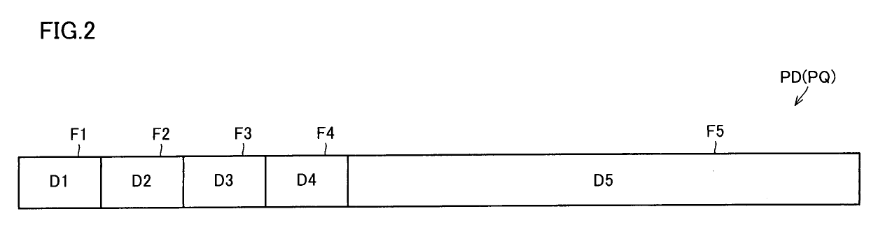

FIG. 2 shows a structure of a packet used in this embodiment. Referring to FIG. 2, packet information PD includes a field F1 storing required state number information D1, a field F2 storing strobe information D2, a field F3 storing load information D3 (i.e., information for loading), a field F4 storing select information D4 (i.e., information for selection) and a field F5 storing other information D5. The other information D5 includes instruction information, data for arithmetic operations and destination information for specifying next instruction information. Packet information PQ, which will be described later, has substantially the same structure as that in FIG. 2.

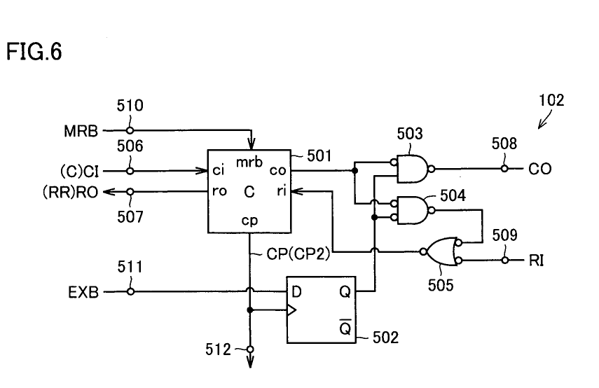

Referring to FIG. 1, signal producing/taking-in circuit 100 includes a C-element 101 with a copy function (i.e., a self-synchronous transfer control circuit with a copy function), a C-element 102 with an erase function (i.e., a self-synchronous transfer control circuit with an erase function), a register 103 for receiving and temporarily holding packet information PD, a copy number decoder 104, which refers to required state number information D1 in packet information PD held in register 103, a state counter 105 for counting states in a sequence, a register 106 with a load function for holding a signal produced as an output 123, a register 107, a register 108 for taking a signal input 124 into signal producing/taking-in circuit 100, a strobe decoder 109, which refers to strobe information D2 in packet information PD held in register 103, a load decoder 110, which refers to load information D3 in packet information PD held in register 103, an output select circuit 111 referring to select information D4 in packet information PD partially held in register 107, a selector 112, terminals 113-117, a terminal 118 receiving packet information PD from the preceding pipeline (i.e., the pipeline in the preceding stage), a terminal 119 sending packet information PQ to the next pipeline (i.e., the pipeline in the next stage), a terminal 120 receiving a load parameter LDP, a terminal 121 receiving a strobe parameter STP, and a terminal 122 receiving a select parameter SLP. Terminals 113-117 have substantially the same functions as terminals 609-613 in FIG. 6.

Signal producing/taking-in circuit 100 in FIG. 1 takes in a value (data) of signal input 124, sends this value to terminal 119 as packet information PQ, and sends a hand shake request to the next pipeline. A series of these operations will be referred to as “strobe” or “strobing” hereinafter.

Load parameter LDP, strobe parameter STP and select parameter SLP are parameters for externally controlling operations of load decoder 110, strobe decoder 109 and output select circuit 111, respectively.

For example, strobe parameter STP instructs strobe decoder 109 on a manner of handling strobe information D2. Strobe parameter STP includes an instruction indicating whether strobe information D2 is to be used or not, and strobe information itself to be used instead of strobe information D2 when strobe information D2 is not used.

Load parameter LDP instructs load decoder 110 on a manner of handling load information D3. Load parameter LDP includes an instruction indicating whether load information D3 is to be used, an instruction indicating whether load information D3 is to be used entirely or partially when it is used, and load information itself to be used instead of load information D3 when load information D3 is not used.

Select parameter SLP instructs output select circuit 111 on a manner of handling select information D4. Select parameter SLP includes an instruction indicating whether select information D4 is to be used or not, and select information itself to be used instead of select information D4 when select information D4 is not used.

These parameters are determined on criteria depending on whether there is such a case that taking-in of signal input 124 or sending of output 123 is to be performed in an access sequence independent of packet information PD, or not, and depending on the required access sequence for the above taking-in or sending.

For example, strobe parameter STP depends the intended timing of taking in signal input 124. In the case where the output includes multiple kinds of signals, load parameter LDP depends on the intended signal value (level) to be set, the timing of such setting and the kind of the signal to be set. Select parameter SLP depends on whether packet information PQ to be output reflects the value taken as signal input 124 or not.

Counter 105 counts states in a sequence. The “states” in the sequence represent respective states in the sequence of producing and sending a signal as output 123, or taking in signal input 124. In connection with this, a count CNT provided by counter 105 represents a number for uniquely specifying each state.

Counter 105 performs the counting operation to provide count CNT in response to the rising edge of clock CP2 provided from C-element 102 with the erase function. The manner of change in count CNT depends on a signal FEB in response to every rising edge of clock CP2. When signal FEB is at a level L (low), count CNT changes to a number 0 (state 0) indicating an initial state. When signal FEB is at a level H (high), count CNT changes to a number of the next state (i.e., state (N+1) if last state is state N, where N is an integer). Since count CNT changes in response to every rising edge of clock CP2, the number of state represented by count CNT is used not only for distinguishing the sequence of logical signal change but also for distinguishing the period determined based on a period between rising edges of clock CP2, e.g., for changing a signal after several states from last signal change in a certain state.

Copy number decoder 104 receives necessary state number information D1, decodes it according to a format required by C-element 101 with the copy function, and provides data 131 representing a result of this decoding to C-element 101 with the copy function.

Count CNT of counter 105 is applied to strobe decoder 109, load decoder 110 and output select circuit 111.

Strobe decoder 109 and load decoder 110 obtain a next state number according to a combination of signal FEB of C-element 101 with the copy function and count CNT of counter 105. More specifically, the next state number is obtained, e.g., such that the next state is state 0 when signal FEB is at the level L, and the next state is state (CNT+1) when signal FEB is at the level H. Strobe decoder 109 performs the decoding based on the next state number thus obtained, strobe information D2 and strobe parameter STP, determines based on the result of this decoding whether the next state requires the strobing of signal input 124, and provides the result of this determination to C-element 102 with the erase function as an erase instruction EXB.

Based on the obtained next state number, load information D3 and load parameter LDP, load decoder 110 determines whether the next state requires the update (partial or entire update) of the information held in register 106 with the load function or not, and provides the result of this determination to register 106 with the load function as a load signal 133 and a data signal 132. Load signal 133 instructs register 106 with the load function to update or not to update the information, and data signal 132 represents information to be used for update.

Based on received decode result data 131, C-element 101 with the copy function copies and outputs, if necessary, a handshake request pulse indicated by signal CI received via terminal 113. Register 107 receives and holds information contained in information D1-D5 of packet information PD, which is held in and output from register 103, and more specifically the information, which is to be passed through signal producing/taking-in circuit 100 as it is (and is to be applied to terminal 119 as it is).

Strobe decoder 109 determines the timing of strobe, i.e., the timing of taking in signal input 124 into signal producing/taking-in circuit 100 based on strobe information D2, next state number, which is obtained as described before, and strobe parameter STP received through terminal 121. According to the timing other than the strobe timing thus determined, C-element 102 with the erase function is supplied with erase instruction EXB for prohibiting external output of the handshake request pulse from signal producing/taking-in circuit 100. Signal FEB is flag information of negative logic related to a signal C among the plurality of signals C of handshake requests, which are output by copying the same handshake request (signal CI) multiple times by C-element 101 with the copy function. Particularly, the flag information of signal FEB indicates that signal C of the handshake request obtained by the first copying operation is output. It is assumed that one copying provides one signal C.

Output select circuit 111 receives count CNT indicating the current state number. Based the indicated current state number, select information D4 and select parameter SLP, output select circuit 111 determines which one between the input data taken and held in register 108 in the current state (i.e., data indicated by signal input 124) and a part of original packet information PD held in register 107 is to be selected for output, and provides the result of this determination to selector 112 as a select signal 130.

In accordance with select signal 130, selector 112 selectively receives the data held in register 108 and a part of original packet information PD held in register 107, and provides it to terminal 119. In this operation, register 107 provides the information held therein to terminal 119 in response to clock pulse CP2. Therefore, packet information PQ formed of the information provided from selector 112 and the information provided from register 107 is sent from terminal 119 to the next pipeline.

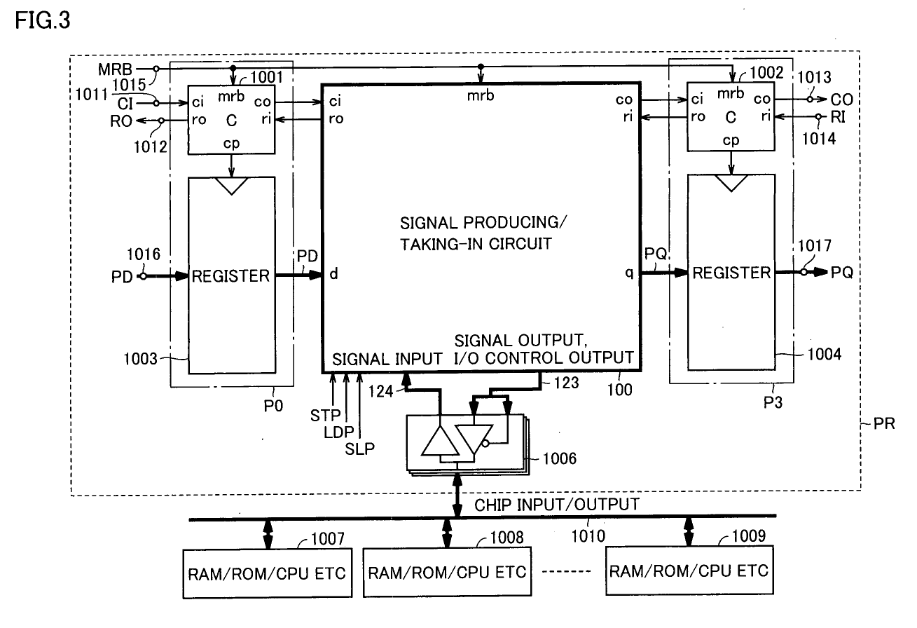

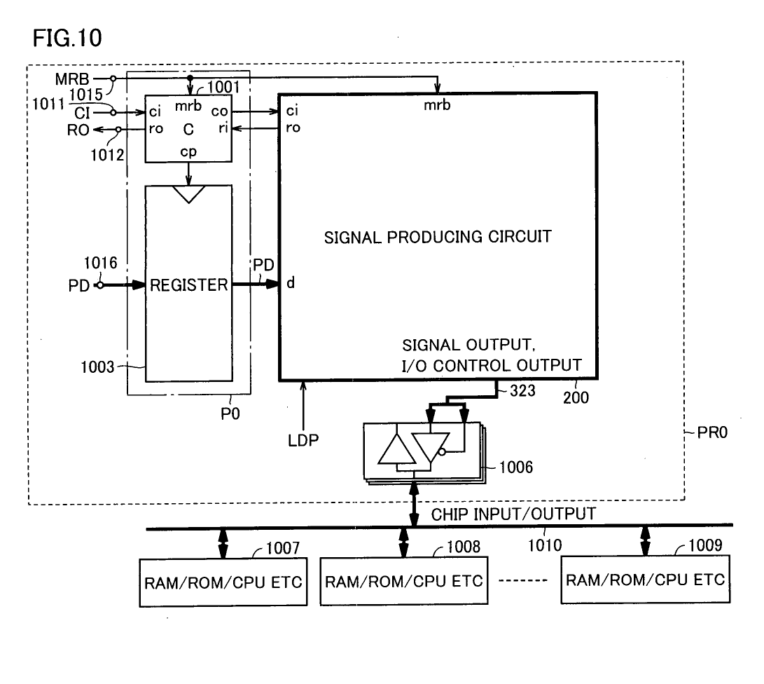

FIG. 3 shows an example of a data-driven processor PR, in which signal producing/taking-in circuit 100 shown in FIG. 1 is arranged. The operation of this example is substantially the same as that in FIG. 10, and therefore description thereof is not repeated.

In accordance with the copy instruction applied from the preceding pipeline, C-element 101 with the copy function copies the handshake request indicated by signal CI to provide the required number of requests in accordance with the copy instruction provided from the preceding pipeline. Thereby, C-element 101 provides the plurality of handshake requests indicated by signal C to C-element 102 with the erase function. An example of a structure for the above operation is disclosed in Japanese Patent Laying-Open No. 2001-282765. For the sake of convenience, this embodiment employs the structure disclosed therein.

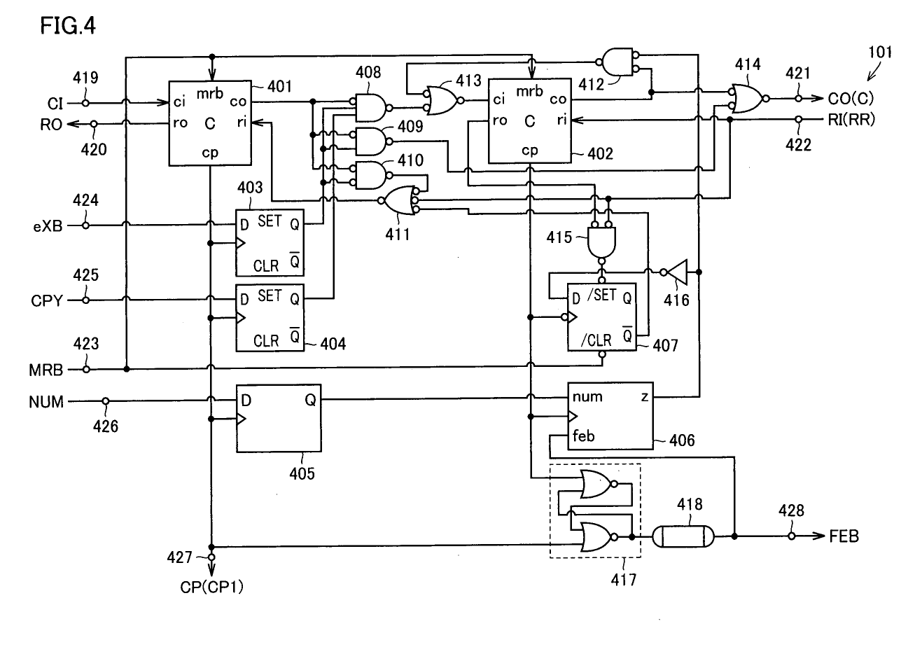

FIG. 4 shows a structure of C-element 101 with the copy function according to this embodiment. Referring to FIG. 4, C-element 101 with the copy function includes C-elements 401 and 402, terminals 419-428, and registers 403, 404 and 405, which receive and hold an erase instruction eXB, a copy instruction CPY and copy number data NUM designating the times of copying of the handshake request applied from copy number decoder 104 via terminals 424, 425 and 426, respectively. C-element 101 with the copy function also includes a counter 406, a register 407, logic gate circuits 408-416 and 418, and a flip-flop circuit 417. Erase instruction eXB, copy instruction CPY and copy number data NUM are designated by decode result data 131. Terminals 419 and 420 are connected to terminals 113 and 114, respectively, and terminal 423 is connected to terminal 117. Terminal 427 is connected to register 103, and terminal 428 is connected to strobe decoder 109, state counter 105 and load decoder 110. Terminals 421 and 422 are connected to C-element 102.

If erase instruction eXB (negative logic) applied from terminal 424 is at the level L, output of the handshake request to C-element 102 with the erase function is suppressed (erased). When erase instruction EXB is at the level H, and copy instruction CPY (positive logic) applied via terminal 425 is at the level L, only one handshake request is issued to C-element 102 with the erase function (and copying is not performed).

If erase instruction eXB is at the level H and copy instruction CPY is at the level H, the handshake request is copied in accordance with copy number data NUM applied via terminal 426 so that the plurality of handshake requests are issued to C-element 102 with the erase function (handshake request is copied). In this case, the handshake requests of ((value indicated by copy number data NUM)+2) in number are issued.

Counter 406 counts the value indicated by copy number data NUM held in register 405, and will issue a signal at the level H to logic gates 412 and 416 for an output Z after the end of counting. Before the end of counting, counter 406 issues a signal at the level L from output Z. For suppressing the output of signal RO indicating handshake allowance to the preceding pipeline until the end of copying, register 407 and logic gates 415 and 416 operate to hold the state indicating that the copying is being performed.

Logic gates 408-410 operate as follows in accordance with the combination of erase instruction eXB and copy instruction CPY held in registers 403 and 404. First, logic gates 408-410 performs the control to attain or not to attain each of such states that signal CO of handshake request is issued to C-element 402 via logic gate 413 (in the case of not erasing the handshake request but copying it), that the handshake request is provided from C-element 401 to the next stage (in the case of not erasing the handshake request), and that the handshake request is provided from C-element 401 as a reception signal (signal RI) of C-element 401 itself via logic gate 411 (in the case of erasing the handshake request).

Logic gate 411 merges a signal RR of handshake allowance sent from the next stage, the handshake allowance sent from C-element 402 and the feedback signal of the handshake request sent from C-element 401 into signal RI of the handshake allowance to be sent to C-element 401.

Logic gates 412 and 413 operate in accordance with an output Z of counter 406 to feed back the handshake request output (signal CO) of C-element 402, which is performing the copy operation, to the handshake request input (signal CI) of C-element 402 itself.

Logic gates 414 merges the handshake request outputs (signals CO) of C-elements 401 and 402 into the handshake request (signal C) to be sent to C-element 102 with the erase function, and provides it to terminal 421.

Flip-flop circuit 417 and logic gate 418 produce signal FEB indicating whether the handshake request (signal C) issued to C-element 102 with the erase function is the first request or not, and provides it to terminal 428.

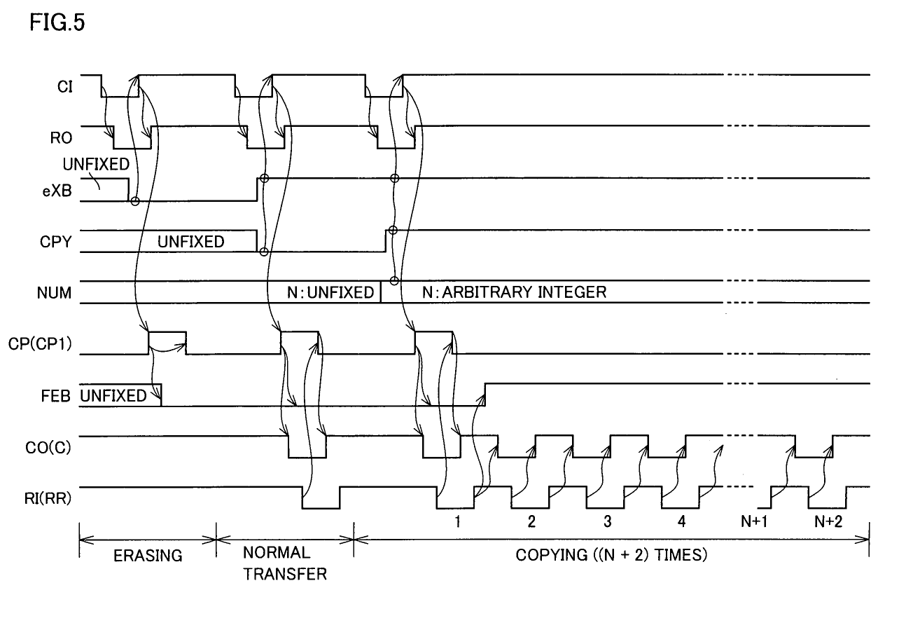

C-element 101 with the copy function shown in FIG. 4 operates in accordance with a timing chart of FIG. 5. This timing chart is substantially the same as that in FIG. 2 of Japanese Patent Laying-Open No. 2001-282765, and therefore description thereof will not be given hereinafter.

C-element 102 with the erase function shown in FIG. 1 has a function of suppressing output of the handshake request to the next pipeline in accordance with the erase instruction sent from the preceding pipeline. FIG. 6 shows a structure of C-element 102 with the erase function.

Referring to FIG. 6, C-element 102 with the erase function includes terminals 506-512, a C-element 501, a register 502 receiving and holding erase instruction EXB applied via terminal 511, and logic gates 503 and 504. Erase instruction EXB held in register 502 is applied to logic gates 503 and 504. When erase instruction EXB of negative logic sent from terminal 511 is at the level L, C-element 102 with the erase function suppresses (i.e., erases) the output of the handshake request (signal CO) to the next pipeline. When it is at the level H, C-element 102 with the erase function issues the handshake request (one request) to the next pipeline.

In accordance with erase instruction EXB, logic gates 503 and 504 control to issue (not erase) the handshake request to the next stage or not to issue it, and also control to feedback (erase) the handshake request sent from C-element 501 as the reception signal, i.e., signal RI to C-element 501 itself or not to feed back it.

Logic gate 505 merges signal RI, which is sent from the next pipeline for indicating the handshake allowance, and the feedback of signal CO, which is the output of handshake request of C-element 501, into signal RI of handshake allowance for C-element 501, and provides it to C-element 501.

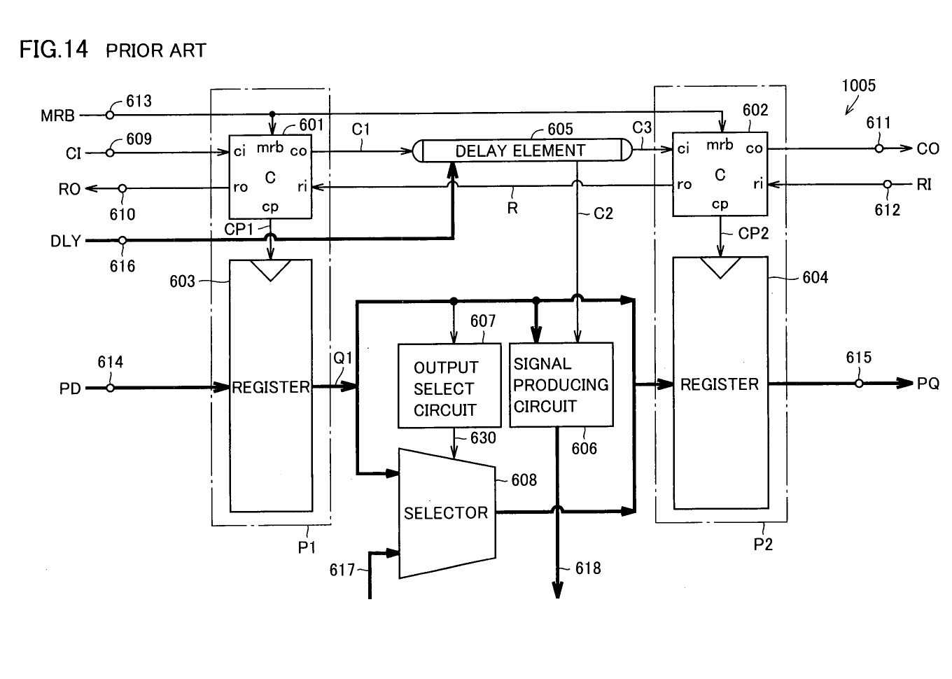

Terminals 506-510 have substantially the same functions as terminals 609-613 in FIG. 14.

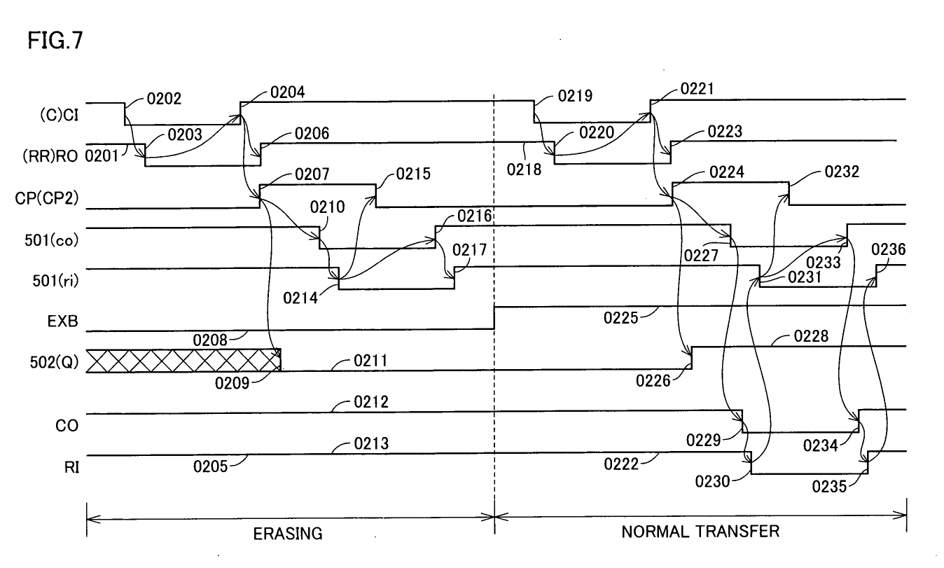

Referring to FIG. 7, an operation of C-element 102 with the erase function shown in FIG. 6 will now be described. First, description will be given on the case of the erase operation, which is performed when erase instruction EXB is at the level L. In the handshake-allowed state (see state 0201), it is assumed that C-element 501 receives, as signal CI sent from terminal 506, the handshake request (see state 0202) of signal C issued from C-element 101 with the copy function. In this case, it sends, as the handshake allowance, signal RR to C-element 101 with the copy function via terminal 507 (see state 0203).

When C-element 101 with the copy function receives signal RR, it will issue signal C indicating handshake completion after a predetermined time. Signal C is applied, as signal CI, to C-element 501 via terminal 506 (see state 0204).

C-element 501 receives signal CI, and also receives signal RI indicating that the next pipeline is in the handshake-allowed state (see state 0205). Therefore, C-element 501 issues signal RO (signal RR) indicating the handshake-allowed state (see state 0206) to C-element 101 with the copy function via terminal 507, and issues the rising edge (see state 0207) of clock CP (CP2) to terminal 512 and register 502. In response to the reception of this rising edge of clock CP (CP2), register 502 receives and holds the level L (see state 0208) of erase instruction EXB applied from terminal 511. Consequently, the output signal on a terminal Q of register 502 is fixed to the level L (see state 0209).

After a predetermined time, logic gate 503 receives an inverted signal of output signal CO of C-element 501, which is the handshake request, and the signal on terminal Q of register 502 (see states 0210 and 0211) so that the output signal of logic gate 503 is at the level H. Consequently, signal CO of the handshake request is not sent to the next pipeline via terminal 508 (see state 0212). Therefore, the next pipeline does not apply signal RI indicating the handshake reception to terminal 509 (see state 0213).

However, the output signal sent from terminal Q of register 502 is at the level L (see state 0210) so that the handshake request issued from C-element 501 (see state 0210) is fed back via logic gates 504 and 505 to C-element 501 as the reception of the handshake request (see state 0214). Thereby, C-element 501 issues the falling edge (see state 0215) of clock CP (CP2).

After a predetermined time, C-element 501 issues a signal of handshake completion (see state 0216). This signal is fed back as a signal of handshake allowance (see state 0217) to C-element 501 via logic gates 504 and 505. By the operations described above, C-element 102 with the erase function performs the handshake with C-element 101 with the copy function, and suppresses (erases) the sending of the handshake request to the next pipeline.

Description will now be given on an operation in the case where the handshake request is normally transferred (in the case where erase instruction EXB is at the level H).

In the operation of issuing signal RO (signal RR) indicating the handshake allowance from C-element 501 to C-element 101 with the copy function via terminal 507 (see state 0218), C-element 501 issues signal RO (signal RR) indicating handshake reception (see state 0220) to C-element 101 with the copy function via terminal 507 when it receives signal CI (signal C) indicating the handshake request (see state 0219) issued from C-element 101 with the copy function.

When a predetermined time elapses after C-element 101 with the copy function accepts signal RO (signal RR) of the handshake reception, C-element 501 receives the handshake completion (see state 0221) as signal CI (signal C), and determines based on signal RI sent from the next pipeline that the next pipeline is in the handshake-allowed state (see state 0222). Thereby, C-element 501 sends signal RO (signal RR) indicating the handshake allowance (see state 0223) to C-element 101 with the copy function, and also sends the rising edge (see state 0224) of clock CP.

When register 502 receives the rising edge of clock CP (CP2), it receives and holds erase instruction EXB at the level H (see state 0225) applied thereto so that the signal sent from terminal Q of register 502 is fixed at the level H (see state 0226).

Further, after a predetermined time, C-element 501 issues a signal of the handshake request (see state 0227) to logic gate 503. In this operation, since the signal sent from terminal Q of register 502 to logic gate 503 is at the level H (see state 0228), the signal sent from logic gate 503 is applied to the next pipeline via terminal 508 as signal CO of the handshake request (see state 0229).

Since the next pipeline receives the handshake request via terminal 508, C-element 102 with the erase function receives signal RI indicating the handshake reception (see state 0230) from the next pipeline via terminal 509. The received signal RI is applied as the handshake reception (see state 0231) to C-element 501 via logic gate 505. Thereby, C-element 501 issues the falling edge (see state 0232) of clock CP (CP2). Further, after a predetermined time, C-element 501 issues the signal of handshake completion (see state 0233) to logic gates 503 and 504. During this operation, the output signal sent from register 502 is at the level H (see state 0228), and is applied to logic gate 503 so that logic gate 503 issues signal CO indicating the handshake completion to the next pipeline via terminal 508′ (see state 0234).

When the next pipeline receives signal CO via terminal 508, it issues signal RI indicating the handshake allowance so that C-element 102 with the erase function receives signal RI via terminal 509 (see state 0235). Signal RI is applied as the signal of handshake reception (see state 0236) to C-element 501 via logic gate 505.

Through the above operations, C-element 102 with the erase function performs the handshake with C-element 101 with the copy function, and further can perform the handshake with the next pipeline.

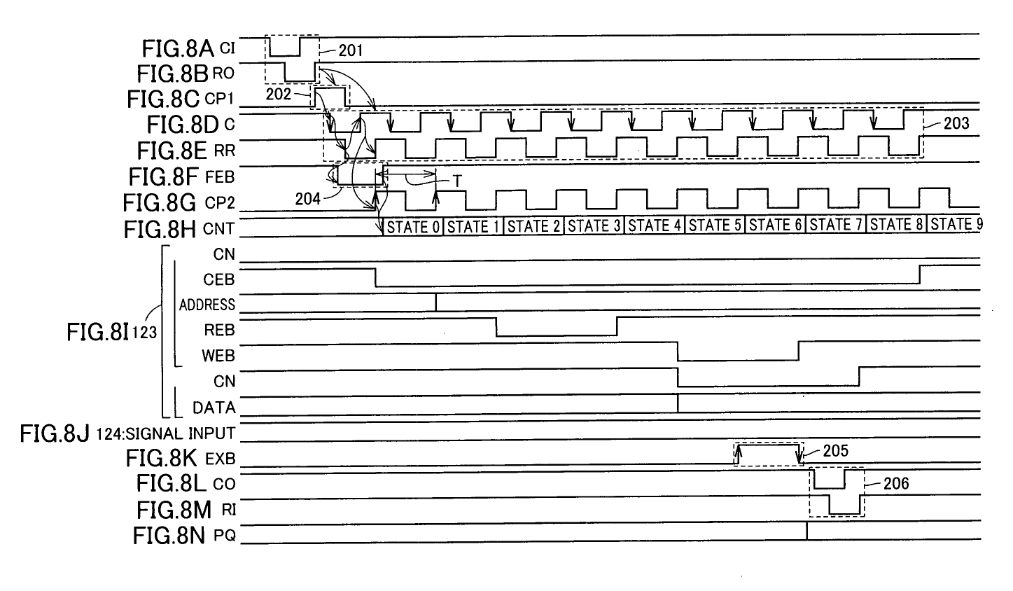

The operation of signal producing/taking-in circuit 100 in FIG. 1 will now be described with reference to timing charts of FIGS. 8A-8N. In the timing charts, signals corresponding to those in FIG. 1 bear the same reference characters, respectively. For the sake of illustration, output 123 represents several kinds of signals included in output 123, and thus represents a signal CEB (chip enable signal) used for accessing memories such as a ROM and a RAM, a signal REB (read enable signal), a signal WEB (write enable signal), a signal ADDRESS (address signal), a signal DATA (data signal) and an I/O control signal CN controlling output of these signals.

When the handshake is performed between the preceding pipeline and C-element 101 with the copy function in response to the handshake request sent from the preceding pipeline, which is not shown, (see state 201), C-element 101 with the copy function issues a clock CP1 to register 103 (see state 202). When register 103 receives clock CP1, it receives and holds packet information PD sent from the preceding pipeline. In parallel with this, copy number decoder 104 receives required state number information D1 applied thereto, decodes the required state number information D1 thus received in accordance with a format required by C-element 101 with the copy function, and provides decode result data 131 to C-element 101 with the copy function. Decode result data 131 includes erase instruction EXB, copy instruction CPY and copy number data NUM. In this example, it is assumed that decode result data 131 instructs the copying of the handshake request to produce ten copies.

The “state number required for the signal producing/taking-in” represents the number of states, which are required for forming the sequences of the signal production and signal take-in. More specifically, the above state number is based on a period T between the rising edges of clock CP2 issued from C-element 102 with the erase function, and is equal to the number of periods T corresponding to the time, which is required in the sequences of the signal production and signal take-in. The state number required for the signal producing/taking-in is indicated by required state number information D1.

Thereafter, C-element 101 with the copy function provides the plurality of handshake requests produced by the copying, i.e., the ten handshake requests (falling edges of signal C) to C-element 102 with the erase function (see state 203).

In this operation, signal FEB is at the level L (see state 204) only when the initial handshake is performed as already described, and is at the level H when the handshake other than the initial handshake is performed. Every time the handshake corresponding to each handshake request, which is produced by copying and is issued, is completed between C-element 101 with the copy function and C-element 102 with the erase function, C-element 102 with the erase function issues clock CP2 to state counter 105, and count CNT provided from state counter 105 changes in accordance with clock CP2 and the level of signal FEB.

Load decoder 110 receives load information D3 in packet information PD held in register 103, signal FEB, count CNT provided from state counter 105 and load parameter LDP externally applied via terminal 120, and decodes them to produce and send load signal 133 and data signal 132 to register 106 with the load function.

Every time C-element 102 with the erase function receives clock CP2 issued in synchronization with input of a handshake request C, register 106 with the load function updates the value (output 123) held thereby by using corresponding data signal 132 if load signal 133 sent from load decoder 110 has instructed the update of information, and issues the updated value. This will be described specifically with reference to the timing charts of FIGS. 8A-8N. Signal CEB is at the level H during periods before state indicated by count CNT, and is at the level L during periods before state 9. Likewise, signal ADDRESS indicates a certain value (i.e., a part of packet information PD or a part of load parameter LDP, which is not processed or is processed) during periods before state 1. Likewise, signal REB is at the level H during periods before state 2, and is at the level L during periods before state 4. Signal WEB is at the level H during periods before state 5, and is at the level L during periods before state 7.

I/O control signal CN for signals CEB, ADDRESS, REB and WEB is fixed at the level L. Signal DATA indicates a certain value (i.e., a part of packet information PD or a part of load parameter LDP, which is not processed or is processed) during periods before state 5, and I/O control signal CN of signal DATA is at the level L during a period immediately after state 5 and immediately before state 8, and thereafter will attain the level H.

According to the structure of the data-driven processor, in which signal producing/taking-in circuit 100 shown in FIG. 1 is arranged as shown in FIG. 3, the operations according to the timing charts of FIGS. 8A-8N are performed as follows. Among the signals applied as output 123, an I/O buffer 1006 always outputs signals CEB, ADDRESS, REB and WEB onto a bus 1010. Also, I/O buffer 1006 outputs signal DATA onto bus 1010 during states 5-7. During the other states, the structure in FIG. 3 enters such a state that I/O buffer 1006 can receive data, which is applied from external devices 1007-1009 via bus 1010, and can send the received data as signal input 124 to signal producing/taking-in circuit 100.

Strobe decoder 109 receives strobe information D2 in packet information PD held in register 103, signal FEB, count CNT provided from state counter 105 and strobe parameter STP externally applied via terminal 121. Based on these received items of information, strobe decoder 109 produces erase instruction EXB for suppressing sending of the handshake request to the next pipeline according to timing other than the strobe timing, and provides it to C-element 102 with the erase function.

According to the timing charts of FIGS. 8A-8N, C-element 102 with the erase function issues clock CP2 to register 108 in every state. Therefore, register 108 receives and holds the value of signal input 124 in response to every reception of clock CP2. In the states other than strobing, C-element 102 with the erase function suppresses sending of the handshake request to the next pipeline based on erase instruction EXB applied thereto. Consequently, only in the state for the strobing, the handshake is performed for providing the value of signal input 124 to the next pipeline as packet information PQ.

According to the timing charts of FIGS. 8A-8N, since the strobing is performed in state 6, erase instruction EXB attains the level H immediately before state 6, and changes to the level L immediately before state 7 (see state 205). In response to every reception of clock CP2, register 107 receives and holds a part or a whole of the packet information held in register 103. Register 108 receives and holds signal input 124 in response to every reception of clock CP2.

Output select circuit 111 receives a part of packet information PD held in register 107, count CNT provided from state counter 105 and externally applied select parameter SLP, produces select signal 130 based on these received items of information, and provides select signal 130 to selector 112. Selector 112 receives a part of the packet information held in register 107 and a value (data) of signal input 124 held in register 108, and outputs one of these two items of information, which is selected based on received select signal 130, through terminal 119. Some fields of packet information PQ sent from terminal 119 bear the information, which is output from selector 112 and corresponds to these fields, and the other fields bear the information, which was held in register 107 and corresponds to the other fields. In synchronization with the timing of strobing, C-element 102 with the erase function issues the handshake request to the next pipeline so that the handshake is performed, and packet information PQ is transmitted via terminal 119 (see state 206). As described above, the signal production and the signal take-in can be performed more flexibly depending on the contents of packet information PD applied to signal producing/taking-in circuit 100.

(Second Embodiment)

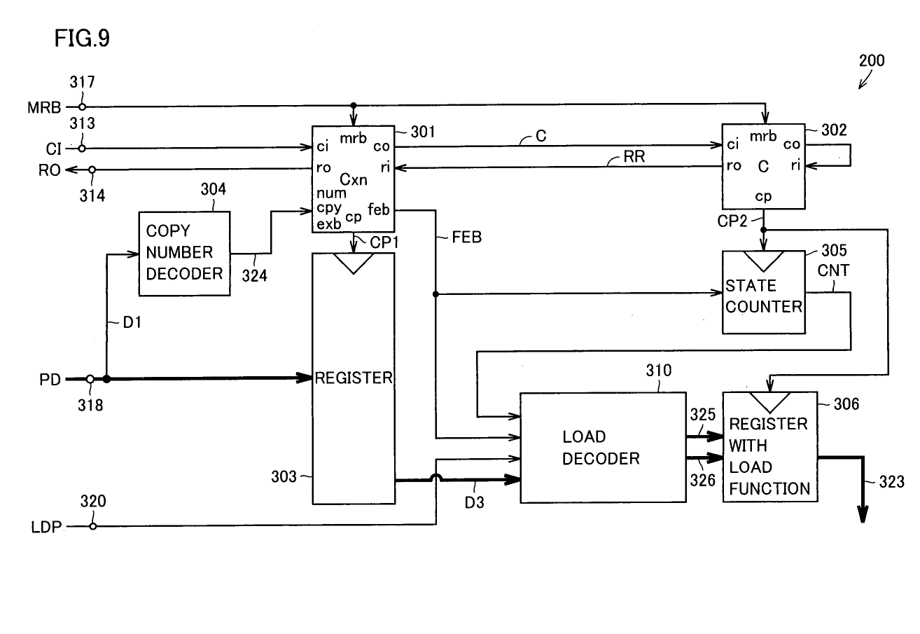

Although the first embodiment has been described in connection with the circuit having the functions of signal production and signal take-in, a second embodiment relates to a circuit, which does not have the signal take-in function, and has only the signal production function. FIG. 9 shows a signal producing circuit 200 according to the second embodiment.

Referring to FIG. 9, signal producing circuit 200 includes a C-element 301 with a copy function, a C-element 302, a register 303 for receiving and temporarily holding packet information PD applied thereto, a copy number decoder 304, a state counter 305 for counting states in a sequence, a register 306 with a load function providing, as a signal output 323, a data signal 326, which is loaded and held, a load decoder 310, a terminal 313 receiving signal CI, a terminal 314 outputting a signal RO, a terminal 317 receiving a signal MRB, a terminal 318 receiving packet information PD, and a terminal 320 receiving load parameter LDP. Terminals 313, 314 and 317 have functions similar to those of terminals 609, 610 and 613 in FIG. 14.

Signal producing circuit 200 receives packet information PD from the preceding pipeline via terminal 318, and provides packet information PQ to the next pipeline via a terminal 319. Load parameter LDP is externally applied via terminal 320 to load decoder 310 for controlling an operation of load decoder 310. Copy number decoder 304 decodes required state number information D1, which is included in packet information PD received via terminal 318, into a format required by C-element 301 with the copy function, and provides decode result data 324 to C-element 301 with the copy function. Decode result data 324 includes copy number data NUM, copy instruction CPY and erase instruction EXB.

Load decoder 310 performs the decoding based on load information D3 in packet information PD held in register 303, count CNT of state counter 305, signal FEB issued from C-element 301 with the copy function and load parameter LDP sent from terminal 320, thereby produces a load signal 325 instructing register 306 with the load function to perform the loading or not to perform it as well as data signal 326 (i.e., data to be loaded to register 306 with the load function), and provides them to register 306 with the load function.

C-element 301 with the copy function, register 303, copy number decoder 304, state counter 305, register 306 with the load function and load decoder 310 has substantially the same functions as C-element 101 with the copy function, register 103, copy number decoder 104, state counter 105, register 106 with the load function and load decoder 110, respectively.

C-element 302 receives signal CO, which is originally to be output to the next pipeline, as signal RI for C-element 302 itself FIG. 10 shows an example of a data-driven processor PR0 incorporating signal producing circuit 200 in FIG. 9. Operations of signal producing circuit 200 can be represented by timing charts, which are substantially the same as those of FIGS. 8A-8N illustrating the first embodiment except for that signals FEB, CO and RI as well as packet information PQ are eliminated.

(Application to Data-Driven Type Processor)

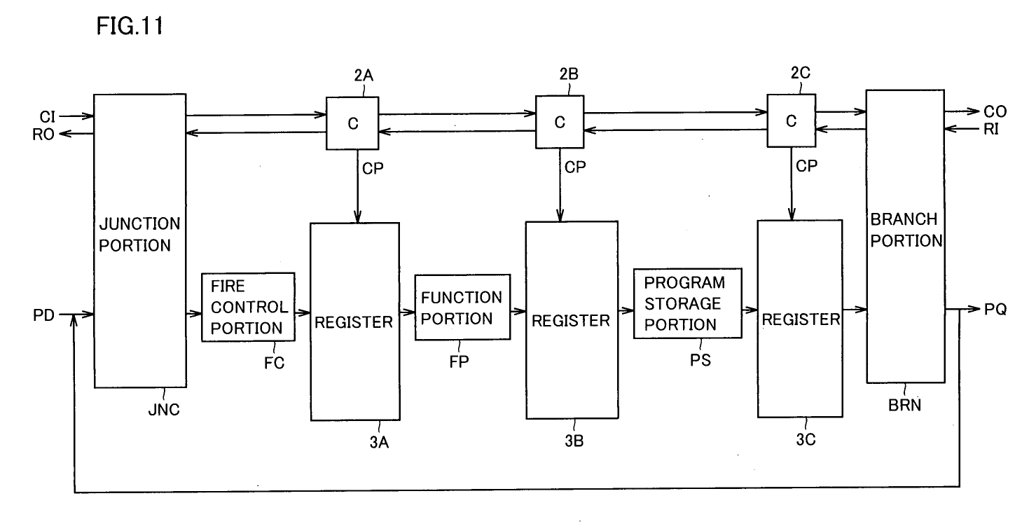

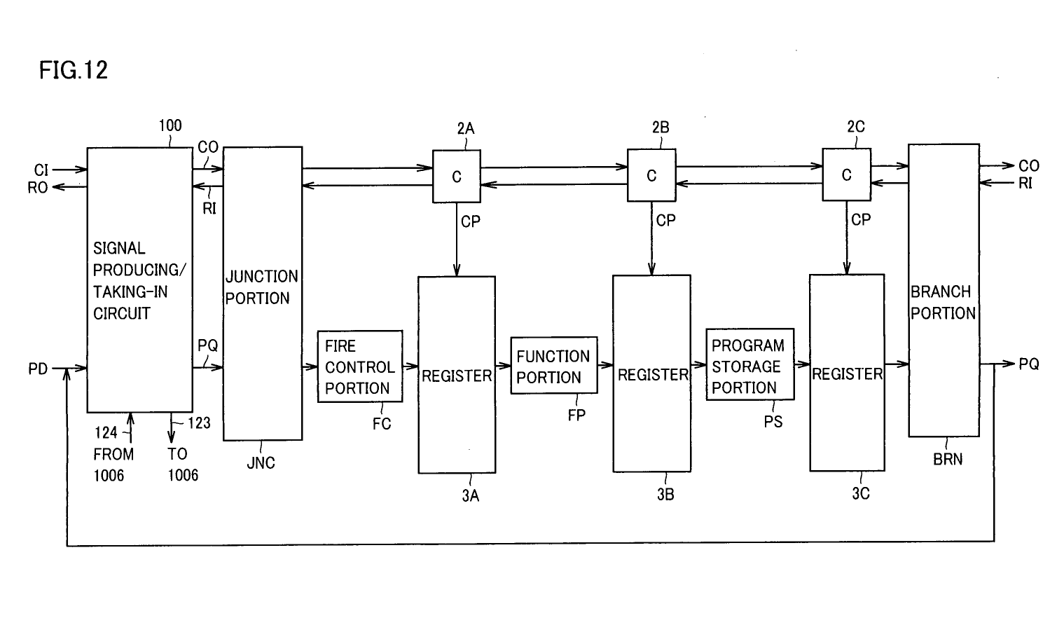

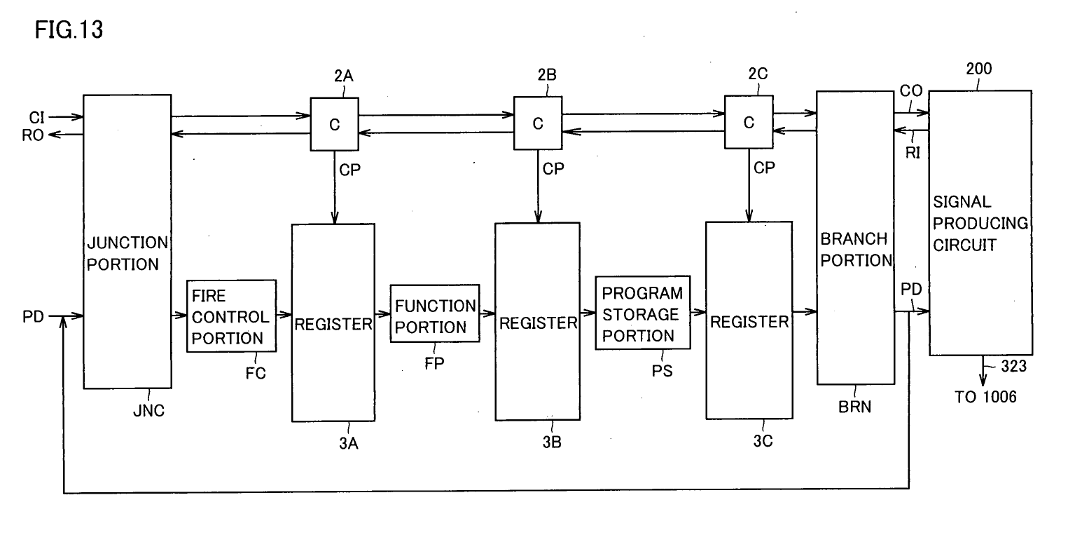

Description will now be given on an example, in which signal producing/taking-in circuit 100 or signal producing circuit 200 described above is incorporated in the data-driven processor. FIG. 11 shows a general structure of the data-driven processor. FIG. 12 shows a structure of the data-driven processor in FIG. 11 and signal producing/taking-in circuit 100 incorporated therein, and FIG. 13 shows a structure of the data-driven processor in FIG. 11 and signal producing circuit 200 incorporated therein. In FIG. 11, the data-driven processor includes a junction portion JNC, a fire control portion FC, a function portion FP, a program storage portion PS and a branch portion BRN as well as three pipelines. The first pipeline is arranged between fire control portion FC and function portion FP, and has a C-element 2A and a corresponding register 3A. The second pipeline is arranged between function portion FP and program storage portion PS, and has a C-element 2B and a corresponding register 3B. The third pipeline is arranged between program storage portion PS and branch portion BRN, and has a C-element 2C and a register 3C.

Signal producing/taking-in circuit 100 of the first embodiment can be arranged in any position of the data-driven processor provided that it is located between the pipelines. Thus, signal producing/taking-in circuit 100 of the first embodiment can be arranged upstream to junction portion JNC, in fire control portion FC, in function portion FP as an arithmetic and logic unit, in program storage portion PS or downstream from branch portion BRN. Signal producing circuit 200 of the second embodiment can be arranged at any position provided that it is arranged in the downstream end of the pipeline series. FIG. 12 shows the structure, in which signal producing/taking-in circuit 100 of the first embodiment is arranged upstream to junction portion JNC. FIG. 13 shows the structure, in which signal producing circuit 200 of the second embodiment is arranged downstream from branch portion BRN. Signal MRB, parameters STP, LDP and SLP are not shown in FIGS. 12 and 13.

Although the present invention has been described and illustrated in detail, it is clearly understood that the same is by way of illustration and example only and is not to be taken by way of limitation, the spirit and scope of the present invention being limited only by the terms of the appended claims.

1. A data transfer control device for transferring a request pulse applied for data transfer from a preceding stage to a next stage based on an instruction signal instructing allowance or prohibition of said data transfer, comprising:
a first self-synchronous transfer control circuit receiving said request pulse from said preceding stage, copying the received request pulse based on received number data, and successively outputting said request pulses produced by the copying;
a requested data register receiving and holding requested data sent from said preceding stage and requested as data to be transferred in response to every reception of said request pulse by said first self-synchronous transfer control circuit;
a second self-synchronous transfer control circuit outputting received said request pulse to the next stage in response to every reception of said request pulse sent from said first self-synchronous transfer control circuit during a period except for an erase period indicated by the applied erase instruction signal, and suppressing the output of said received request pulse to the next stage in response to every reception of said request pulse sent from said first self-synchronous transfer control circuit during said erase period;
an erase instructing circuit producing said erase instruction signal based on applied information, and providing produced said erase instruction signal to said second self-synchronous transfer control circuit; and
an input register receiving and holding data sent externally in response to every reception of said request pulse by said second self-synchronous transfer control circuit, wherein
when said second self-synchronous transfer control circuit output said request pulse to the next stage, contents of said input register are output as said requested data to said next stage.

2. The data transfer control device according to claim 1, further comprising:
a number data producing portion producing said number data based on said requested data applied from said preceding stage, and providing produced said number data to said first self-synchronous transfer control circuit.

3. The data transfer control device according to claim 1, further comprising:
a counter circuit counting said request pulses successively output from said first self-synchronous transfer control circuit when said counter circuit receives said request pulse from said preceding stage, and providing a count.

4. The data transfer control device according to claim 3, wherein
said erase instructing circuit produces said erase instruction signal based on said requested data held in said requested data register and said count provided from said counter circuit.

5. The data transfer control device according to claim 3, wherein
said erase instructing circuit produces said erase instruction signal based on said requested data held in said requested data register, said count provided from said counter circuit and an externally applied erase parameter.

6. The data transfer control device according to claim 3, further comprising:
a holding register receiving and holding said requested data held in said requested data register in response to every reception of said requested pulse by said second self-synchronous transfer control circuit;
a selector outputting contents of said holding register or contents of said input register based on an applied select signal; and
a select signal producing circuit producing and sending said select signal to said selector, wherein
said select signal producing circuit produces and sends produced said select signal to said selector based on said requested data held in said holding register and said count provided from said counter circuit.

7. The data transfer control device according to claim 3, further comprising:
a holding register receiving and holding said requested data held in said requested data register in response to every reception of said requested pulse by said second self-synchronous transfer control circuit;
a selector outputting contents of said holding register or contents of said input register based on an applied select signal; and
a select signal producing circuit producing and sending said select signal to said selector, wherein
said select signal producing circuit produces and sends produced said select signal to said selector based on said requested data held in said holding register, said count provided from said counter circuit and an externally applied select parameter.

8. The data transfer control device according to claim 3, further comprising:
an external register receiving, holding and externally providing output data to be provided externally based on a load signal in response to every reception of said requested pulse by said second self-synchronous transfer control circuit; and
a signal producing portion producing and sending said output data and said load signal to said external register, wherein
said load signal instructs said external register to update or not to update contents held in said external register with said output data, and
said signal producing portion produces said output data and said load signal based on said requested data held in said requested data register and the count provided from said counter circuit, and provides produced said output data and produced said load signal to said external register.

9. The data transfer control device according to claim 8, further comprising:
a holding register receiving and holding said requested data held in said requested data register in response to every reception of said requested pulse by said second self-synchronous transfer control circuit;
a selector outputting contents of said holding register or contents of said input register based on an applied select signal; and
a select signal producing circuit producing and sending said select signal to said selector, wherein
said select signal producing circuit produces and sends produced said select signal to said selector based on said requested data held in said holding register and said count provided from said counter circuit.

10. The data transfer control device according to claim 8, further comprising:
a holding register receiving and holding said requested data held in said requested data register in response to every reception of said requested pulse by said second self-synchronous transfer control circuit;
a selector outputting contents of said holding register or contents of said input register based on an applied select signal; and
a select signal producing circuit producing and sending said select signal to said selector, wherein
said select signal producing circuit produces and sends produced said select signal to said selector based on said requested data held in said holding register, said count provided from said counter circuit and an externally applied select parameter.

11. The data transfer control device according to claim 3, further comprising:
an external register receiving, holding and externally providing output data to be provided externally based on a load signal in response to every reception of said requested pulse by said second self-synchronous transfer control circuit; and
a signal producing portion producing and sending said output data and said load signal to said external register, wherein
said load signal instructs said external register to update or not to update contents held in said external register with said output data, and
said signal producing portion produces said output data and said load signal based on said requested data held in said requested data register, the count provided from said counter circuit and an externally applied load parameter, and provides produced said output data and said load signal to said external register.

12. The data transfer control device according to claim 11, further comprising:
a holding register receiving and holding said requested data held in said requested data register in response to every reception of said requested pulse by said second self-synchronous transfer control circuit;
a selector outputting contents of said holding register or contents of said input register based on an applied select signal; and
a select signal producing circuit producing and sending said select signal to said selector, wherein
said select signal producing circuit produces and sends produced said select signal to said selector based on said requested data held in said holding register and said count provided from said counter circuit.

13. The data transfer control device according to claim 11, further comprising:
a holding register receiving and holding said requested data held in said requested data register in response to every reception of said requested pulse by said second self-synchronous transfer control circuit;
a selector outputting contents of said holding register or contents of said input register based on an applied select signal; and
a select signal producing circuit producing and sending said select signal to said selector, wherein
said select signal producing circuit produces and sends produced said select signal to said selector based on said requested data held in said holding register, said count provided from said counter circuit and an externally applied select parameter.

14. The data transfer control device according to claim 1, further comprising:
an external register receiving, holding and externally providing output data to be provided externally based on a load signal in response to every reception of said requested pulse by said second self-synchronous transfer control circuit; and
a signal producing portion producing and sending said output data and said load signal to said external register, wherein
said load signal instructs said external register to update or not to update contents held in said external register with said output data.

15. The data transfer control device according to claim 1, further comprising:
a holding register receiving and holding said requested data held in said requested data register in response to every reception of said requested pulse by said second self-synchronous transfer control circuit;
a selector outputting contents of said holding register or contents of said input register based on an applied select signal; and
a select signal producing circuit producing and sending said select signal to said selector.

16. The data transfer control device according to claim 15, wherein
said select signal producing circuit produces and sends said select signal to said selector based on said requested data held in said holding register.

17. A data transfer control device for receiving a request pulse applied for data transfer from a preceding stage based on an instruction signal instructing allowance and prohibition of said data transfer, comprising:
a first self-synchronous transfer control circuit receiving said request pulse from said preceding stage, copying said received request pulse based on received number data, and successively outputting said request pulses produced by the copying;
a requested data register receiving and holding requested data sent from said preceding stage and requested as data to be transferred in response to every input of said request pulse by said first self-synchronous transfer control circuit;
a second self-synchronous transfer control circuit receiving said request pulse provided from said first self-synchronous transfer control circuit, an external register receiving, holding and externally providing output data to be provided externally based on a load signal in response to every reception of said request pulse by said second self-synchronous transfer control circuit; and
a signal producing portion producing and sending said output data and said load signal to said external register, wherein
said load signal instructs said external register to update or not to update contents held in said external register with said output data.

18. The data transfer control device according to claim 17, further comprising:
a counter circuit counting said request pulses successively output from said first self-synchronous transfer control circuit when said counter circuit receives said request pulse from said preceding stage, and providing a count, wherein
said signal producing portion produces said output data and said load signal based on said requested data held in said requested data register and the count provided from said counter circuit, and provides produced said output data and produced said load signal to said external register.

19. The data transfer control device according to claim 17, further comprising:
a counter circuit counting said request pulses successively output from said first self-synchronous transfer control circuit when said counter circuit receives said request pulse from said preceding stage, and providing a count, wherein
said signal producing portion produces said output data and said load signal based on said requested data held in said requested data register, the count provided from said counter circuit and an externally applied load parameter, and provides produced said output data and produced said load signal to said external register.

20. A data-driven processor comprising:
a pipeline series formed of pipelines arranged in multiple stages and connected together; and
a data transfer control device arranged in said pipeline series and located between the arbitrary pipelines for transferring a request pulse used for data transfer and applied from the preceding pipeline to the next pipeline based on an instruction signal instructing allowance or prohibition of said data transfer, wherein
said data transfer control device includes:
a first self-synchronous transfer control circuit receiving said request pulse from said preceding pipeline, copying received said request pulse based on received number data, and successively outputting said request pulses produced by the copying;
a requested data register receiving and holding requested data sent from said preceding pipeline and requested as data to be transferred for data-driven processing in response to every reception of said request pulse by said first self-synchronous transfer control circuit;
a second self-synchronous transfer control circuit outputting received said request pulse to the next pipeline in response to every reception of said request pulse sent from said first self-synchronous transfer control circuit during a period except for an erase period indicated by the applied erase instruction signal, and suppressing the output of said received request pulse to the next pipeline in response to every reception of said request pulse sent from said first self-synchronous transfer control circuit during said erase period;
an erase instructing circuit producing said erase instruction signal based on applied information, and providing produced said erase instruction signal to said second self-synchronous transfer control circuit; and
an input register receiving and holding data sent externally in response to every reception of said request pulse by said second self-synchronous transfer control circuit, wherein
when said second self-synchronous transfer control circuit outputs said request pulse to the next pipeline, contents of said input register are output as said requested data to said next pipeline.

21. A data-driven processor comprising:
a pipeline series formed of pipelines arranged in multiple stages and connected together; and
a data transfer control device connected to a downstream end of said pipeline series, wherein
said data transfer control device includes:
a first self-synchronous transfer control circuit operating based on an instructing signal instructing allowance and prohibition of transfer of data to be processed, receiving a request pulse from the preceding pipeline, copying received said request pulse based on received number data, and successively outputting said request pulses produced by the copying;
a requested data register receiving and holding requested data sent from said preceding pipeline and requested as data to be transferred in response to every reception of said request pulse by said first self-synchronous transfer control circuit;
a second self-synchronous transfer control circuit outputting said received request pulse in response to every reception of said request pulse sent from the first self-synchronous transfer control circuit;
an external register receiving, holding and externally providing output data to be provided externally based on a load signal in response to every reception of said request pulse by said second self-synchronous transfer control circuit; and
a signal producing portion producing and sending said output data and said load signal to said external register, wherein
said load signal instructs said external register to update or not to update contents held in said external register with said output data.
